(19) United States
(12) Patent Application Publication
(10) Pub. No.: US 2017/0030531 A1
(43) Pub. Date: Feb. 2, 2017

(54) LIGHT SOURCE AND LIGHTING APPARATUS USING THE SAME

(71) Applicant: Panasonic Intellectual Property Management Co., Ltd., Osaka (JP)

(72) Inventors: Hisao KITAGAWA, Tokyo (JP); Osamu HIKONE, Chiba (JP); Takaaki SHIINO, Osaka (JP)

(21) Appl. No.: 15/222,650

(22) Filed: Jul. 28, 2016

(30) Foreign Application Priority Data
Jul. 30, 2015 (JP) 2015-151304

(51) Int. Cl. F21K 9/62; F21V 7/04; F21V 29/76; F21V 21/26; F21V 31/00; F21V 3/04; F21V 7/06

(52) U.S. Cl. CPC F21K 9/62; F21V 3/0445; F21V 7/041; F21V 7/06; F21V 21/26; F21V 31/00; F21V 29/763; F21Y 2115/10

(57) ABSTRACT

A light source includes: light-emitting elements of different colors, forming a light-emitting element group; a light-emitting element base on which the light-emitting elements are placed in a way that a main optical axis direction intersects a placement surface of the light-emitting element base; a reflection unit including a reflection surface configured to narrow light emitted from the light-emitting element group, a front-side opening portion formed on a front side of the reflection unit in the main optical axis direction, and a rear-side opening portion formed in a rear side of the reflection unit in the main optical axis direction; and a diffusing portion placed in front of the reflection unit in the main optical axis direction, and configured to diffuse the light. In the reflection unit, an area of the front-side opening portion is smaller than that of the rear-side opening portion.

### CROSS REFERENCE TO RELATED APPLICATIONS

This application is based upon and claims the benefit of priority from prior Japanese Patent Application P2015-151304 filed on Jul. 30, 2015; the entire contents of which are incorporated by reference herein.

### BACKGROUND OF THE INVENTION

This disclosure relates to a light source and a lighting apparatus using the same.

A lighting apparatus including: an LED light source; a lens covering a light output side of the LED light source; and a bowl-shaped reflection plate surrounding a peripheral portion of the lens has been known as disclosed in Japanese Patent Application Publication No. 2014-011015 (hereinafter referred to as “Patent Document 1”).

According to Patent Document 1, the color of light emitted from the LED light source is white (single color). The occurrence of unevenness of light projection is inhibited by: diffusing the white light emitted from the LED light source using the lens; and thereby increasing an amount of white light which reaches a reflection surface of the reflection plate.

### SUMMARY OF THE INVENTION

Meanwhile, there is an idea of making a lighting apparatus capable of projecting light of a color selected from various colors such as red and white. Such a lighting apparatus can be made capable of projecting light of a desired color by: using light-emitting elements of different colors; controlling light emission from the light-emitting elements (colors and amounts of light to be emitted therefrom); and mixing the thus-emitted light.

In that case, merely diffusing the emitted light using the lens as in the above related technique is insufficient to mix the light, and accordingly the unevenness of the color may occur.

With this taken into consideration, an object of the present disclosure is to inhibit the occurrence of the color unevenness in a light source capable of emitting light of a color selected from various colors, and in a lighting apparatus using the light source.

A light source according to the present disclosure includes a plurality of light-emitting elements including light-emitting elements of different colors, and forming a light-emitting element group and a light-emitting element base on which the light-emitting elements are placed in a way that a main optical axis direction of the light-emitting elements is a direction intersecting a placement surface of the light-emitting element base.

The light source also includes a reflection unit including a reflection surface configured to adjust passage of light emitted from the light-emitting element group, a front-side opening portion formed on a front side of the reflection unit in the main optical axis direction, and a rear-side opening portion formed in a rear side of the reflection unit in the main optical axis direction.

The light source further includes a diffusing portion placed in front of the reflection unit in the main optical axis direction, and configured to diffuse the light.

In the reflection unit, an area of the front-side opening portion is smaller than that of the rear-side opening portion.

A lighting apparatus according to the present disclosure includes a light source and a reflection plate configured to reflect light emitted from the light source in a main optical axis direction of the light source.

The light source includes a plurality of light-emitting elements including light-emitting elements of different colors, and forming a light-emitting element group and a light-emitting element base on which the light-emitting elements are placed in a way that a main optical axis direction of the light-emitting elements is a direction intersecting a placement surface of the light-emitting element base.

In addition, the light source includes a reflection unit including a reflection surface configured to adjust passage of the light emitted from the light-emitting element group, a front-side opening portion formed on a front side of the reflection unit in the main optical axis direction of the light-emitting elements, and a rear-side opening portion formed in a rear side of the reflection unit in the main optical axis direction of the light-emitting elements.

The light source further includes a diffusing portion placed in front of the reflection unit in the main optical axis direction of the light-emitting elements, and configured to diffuse the light.

In the reflection unit, an area of the front-side opening portion is smaller than that of the rear-side opening portion.

### BRIEF DESCRIPTION OF THE DRAWINGS

FIG. 1 is a perspective view schematically showing an external appearance of a light projector of a first embodiment.

FIG. 2 is a front view showing a light projector main body of the first embodiment.

FIG. 3 is a side view showing the light projector main body of the first embodiment.

FIG. 4 is a cross-sectional view taken along the A-A line of FIG. 2.

FIG. 5 is a front view showing an LED light source of the first embodiment.

FIG. 6 is a cross-sectional view taken along the B-B line of FIG. 5.

FIG. 7 is an exploded perspective view for explaining how to attach the LED light source to a case in the first embodiment.

FIG. 8 is a cross-sectional view taken along the C-C line of FIG. 5.

FIG. 9 is a front view showing an LED board of the first embodiment.

FIG. 10 is a front view showing a light projector main body of a second embodiment.

FIG. 11 is a side view showing the light projector main body of the second embodiment.

FIG. 12 is a cross-sectional view taken along the D-D line of FIG. 10.

FIG. 13 is a perspective view schematically showing an external appearance of a light projector of a third embodiment.

FIG. 14 is a front view showing a light projector main body of the third embodiment.

FIG. 15 is a side view showing the light projector main body of the third embodiment.

FIG. 16 is a cross-sectional view taken along the E-E line of FIG. 14.

FIG. 17 is a perspective view schematically showing an external appearance of a light projector of a fourth embodiment.

FIG. 18 is a front view showing a light projector main body of the fourth embodiment.

FIG. 19 is a side view showing the light projector main body of the fourth embodiment.

FIG. 20 is a cross-sectional view taken along the F-F line of FIG. 18.

### DETAILED DESCRIPTION OF THE PREFERRED EMBODIMENTS

Referring to the drawings, detailed descriptions will be hereinbelow provided for a light source, and a lighting apparatus using the light source, of these embodiments. It should be noted that: a light projector for outdoor use will be hereinbelow shown as an example of the lighting apparatus; and an LED light source will be hereinbelow shown as an example of the light source.

In addition, the following embodiments include components which are similar across the embodiments. For this reason, each of those components will be hereinbelow denoted by a reference sign which is common across the embodiments, and duplicated descriptions will be omitted.

### First Embodiment

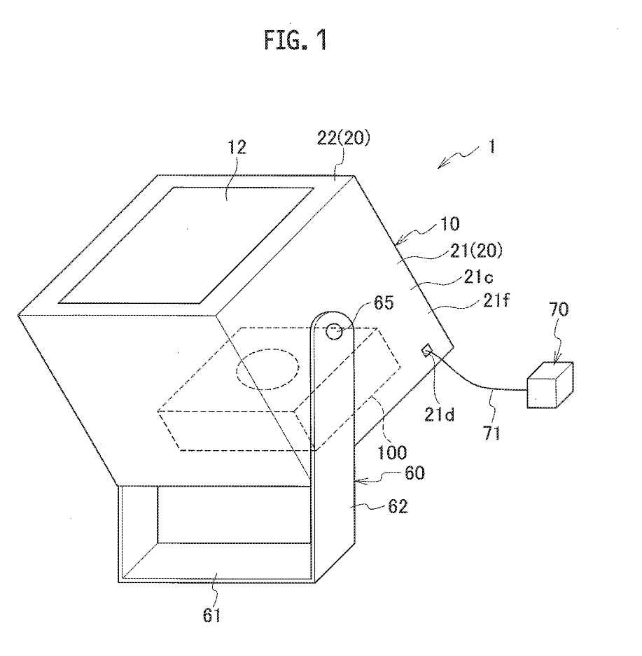

As shown in FIG. 1, a light projector (lighting apparatus) 1 includes a light projector main body 10 including: a light source 100 housed inside the light projector main body 10; and a panel 12 configured to allow light emitted from the light source 100 to pass through the panel 12, and to be projected to the outside of the light projector main body 10 through the panel 12.

The light projector (lighting apparatus) 1 further includes a power supply unit 70 electrically connected to the light projector main body 10 using a cable 71. In this embodiment, the cable 71 is inserted into the inside of the light projector main body 10 through a hole 21d formed in the light projector main body 10, and is electrically connected to a connector 150 of an LED board (light-emitting element base) 130 (described later). Thereby, the cable 71 electrically connects the power supply unit 70 to the light projector main body 10.

In addition, turning on/off the power of the light projector main body 10, etc. is switched by operating the power supply unit 70 electrically connected to the light projector main body 10 using the cable 71.

Furthermore, in this embodiment, the light projector main body 10 is turnably attached to an arm 60. An angle of the panel 12, or a light projection angle at which the light projector main body 10 projects the light to the outside, can be adjusted by adjusting an angle of inclination of the light projector main body 10 relative to the arm 60. Moreover, the arm 60 is capable of holding the light projector main body 10 at a desired angle.

The arm 60 includes: a bottom wall portion 61 enabling the light projector main body 10 to be fixed to a building part such as a wall, a ceiling or a stand; and a pair of side wall portions 62, 62 rising from the two ends of the bottom wall portion 61. The arm 60 can be formed, for example, by bending a metal plate such as a steel plate.

Moreover, the pair of side wall portions 62, 62 are turnably attached at their tip ends to the light projector main body 10. Thereby, the light projector main body 10 is turnably supported by the arm 60.

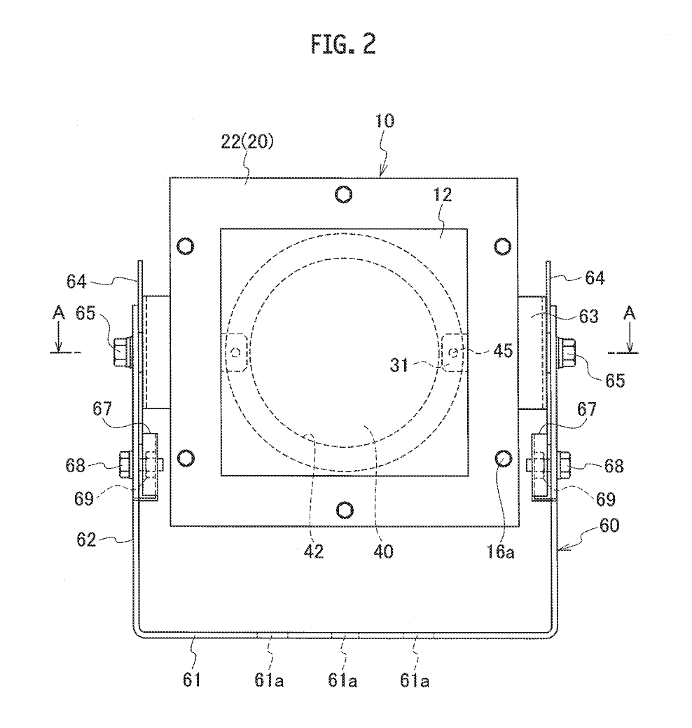

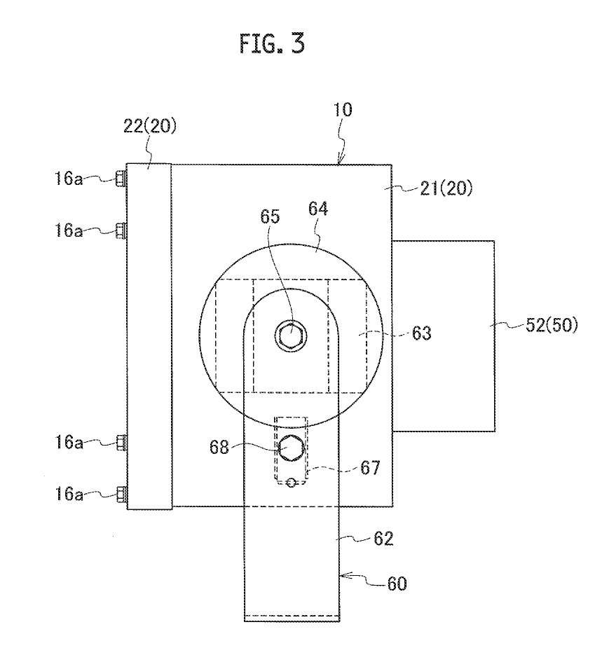

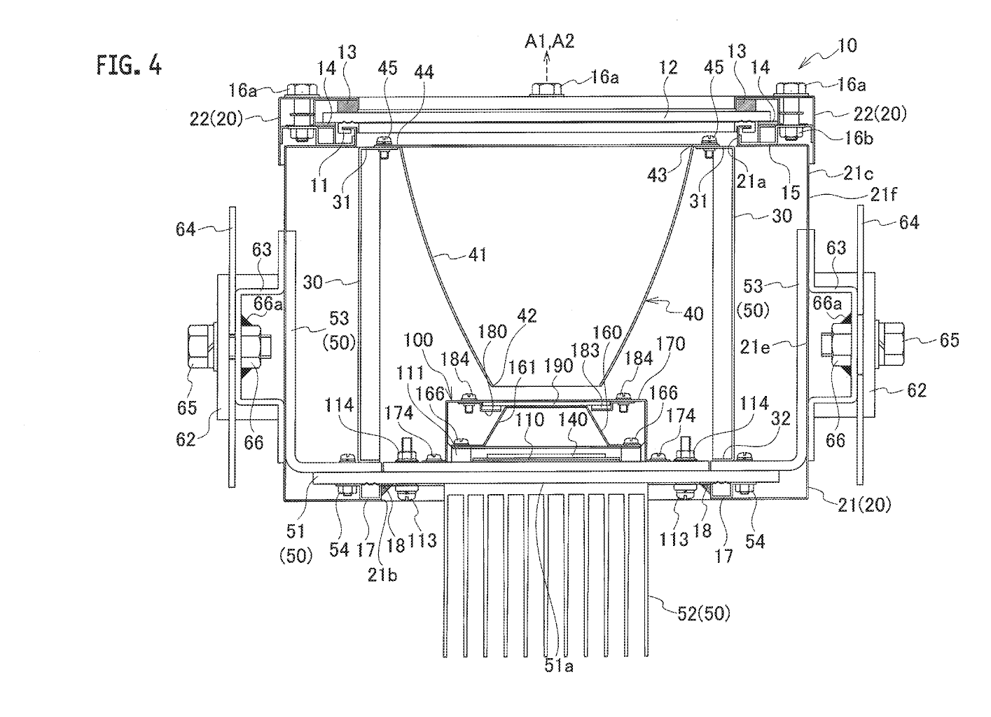

In this embodiment, as shown in FIGS. 2 and 3, a pair of spacers 63 are attached to outer peripheral surfaces 21f of a peripheral wall 21c of a case main body 21, an end of which the panel 12 is attached to. In addition, using bolts 65 and nuts 66, the side wall portions 62, 62 are attached at their tip ends to the spacers 63, respectively. Thereby, the light projector main body 10 is turnably supported by the arm 60. Incidentally, the nuts 66 are fixed to the spacers 63 using adhesives 66a (see FIG. 4).

Furthermore, in this embodiment, disks 64 are interposed between the side wall portions 62 and the spacers 63, respectively. The disks 64 are pressed at their outer periphery sides by pressing plates 67 which are provided to bottom wall portion 61 sides of the side wall portions 62. Thereby, the turn of the light projector main body 10 is restricted. To put it specifically, the disks 64 are held between the pressing plates 67 and the side wall portions 62 by: inserting bolts 68 through nuts 69; and fastening the bolts 68 to the nuts 69. Thereby, the turn of the light projector main body 10 is restricted. Incidentally, the loosening of the bolts 68 releases the disks 64 from being held by the pressing plates 67. Thus, the light projector main body 10 becomes turnable again.

Besides, insertion holes 61a through which to insert fixing screws (not illustrated) are formed in the bottom wall portion 61. The light projector main body 10 can be fixed to the building part such as a wall, a ceiling or a stand using the screws (not illustrated) to be inserted through the insertion holes 61a. Incidentally, in a case where the insertion holes 61a are respectively formed as a circular insertion hole and arc-shaped insertion holes surrounding the circular insertion hole, the light projector main body 10 as fixed to the building part can be turned not only in a vertical direction (direction in which the side wall portions 62 extend), but also in a lateral direction (direction in which the bottom wall portion 61 extends).

Next, referring mainly to FIGS. 4 to 9, detailed descriptions will be provided for the light projector main body 10 of this embodiment.

The light projector main body 10 includes a case 20 to which to fix the panel 12. The light source 100 and a reflection plate 40 are housed in the case 20.

In this embodiment, the case 20 is shaped almost like a rectangular parallelepiped. The substantially rectangular panel 12 is fixed to one end side (a front side of the case 20 in a main optical axis A1 direction of the light source 100, which will be described later) of the case 20.

To put it specifically, the case 20 includes the case main body 21 and a frame portion 22. An outer peripheral portion of the panel 12 is held between the case main body 21 and the frame portion 22. Thereby, the panel 12 is fixed to the case 20. In that case, a packing 13 is interposed between a circumferential portion of one surface of the panel 12 and the frame portion 22, and a packing 14 is interposed between a circumferential portion of the other surface of the panel 12 and the case main body 21. This inhibits a gap from being formed between the panel 12 and the frame portion 22, as well as a gap from being formed between the panel 12 and the case main body 21. The inhibition of the formation of the gaps makes it possible to inhibit rain water, dust and the like from entering the inside of the case main body 21 through the gaps.

In this embodiment, the case main body 21 includes the peripheral wall 21c shaped almost like a quadrangle. A front-side opening 21a and a rear-side opening 21b are formed at the two ends (the two sides of the peripheral wall 21c in the main optical axis A1 direction) of the peripheral wall 21c.

The panel 12 is placed on a front side of the case main body 21 in the main optical axis A1 direction in a way to cover the front-side opening 21a.

In addition, when the frame portion 22 is fixed to the case main body 21, a pressing member 15 configured to press the packing 14 forward in the main optical axis A1 direction is continuously provided to a front side of the case main body 21 in the main optical axis A1 direction. The pressing member 15 concurrently exerts a spacer function. A space in which to place nuts 16b, which are used to fix the frame portion 22 to the case main body 21, is formed in front of the case main body 21 in the main optical axis A1 direction by providing the pressing member 15 thereto.

Furthermore, the packing 14 provided to a front side of the pressing member 15 in the main optical axis A1 direction is pressed toward the outer peripheral portion of the rear surface of the panel 12 (the rear-side surface of the panel 12 in the main optical axis A1 direction). This makes it possible to inhibit the formation of the gap between the panel 12 and the case main body 21.

Moreover, a pressing member 11 is provided in front of the case main body 21 in the main optical axis A1 direction. The pressing member 11 presses the panel 12 forward in the main optical axis A1 direction. Incidentally, in this embodiment, the packing 13 to be in contact with the outer peripheral portion of the front surface of the panel 12 (the front-side surface of the panel 12 in the main optical axis A1 direction) is placed in front of the pressing member 11 in the main optical axis A1 direction. For this reason, when the pressing member 11 presses the panel 12 forward in the main optical axis A1 direction, the packing 13 is firmly held between the frame portion 22 and the panel 12. Consequently, the formation of the gap between the panel 12 and the frame portion 22 can be securely inhibited. This makes it possible to inhibit rain water, dust and the like from entering the inside of the case main body 21 through the gap.

It should be noted that the case main body 21 and the frame portion 22 are fixed together using bolts 16a and the nuts 16b.

Meanwhile, a heat radiation unit 50 is provided to a rear side of the case main body 21 in the main optical axis A1 direction in a way to cover the rear-side opening 21b. Heat produced by the light source 100 can be more efficiently discharged to the outside of the case main body 21 through the heat radiation unit 50.

In this embodiment, the heat radiation unit 50 includes: a heat radiation plate 51 fixed to the case main body 21 in a way to cover the rear-side opening 21b; and heat radiation fins 52 provided to a rear-surface 51a of the heat radiation plate 51.

The heat radiation unit 50 further includes an extended portion 53 continuously connected to the heat radiation plate 51, and being in contact with an inner surface 21e of the peripheral wall 21c.

The heat radiation plate 51 and the extended portion 53 are connected together using fastening members 54. A pressing member 17 is fixed to the heat radiation plate 51 using the fastening members 54. The pressing member 17 concurrently exerts a spacer function as well. A space in which to place nut portions of the fastening members 54 configured to fix the heat radiation plate 51 and the extended portion 53 together is formed between the heat radiation plate 51 and the case main body 21 by providing the pressing member 17 thereto.

In addition, the pressing member 17 is fixed to a peripheral portion of the rear-side opening 21b of the case main body 21. The fixing of the pressing member 17 to the heat radiation plate 51 using the fastening members 54 makes it possible to inhibit a gap from being formed between the heat radiation plate 51 and the case main body 21. Furthermore, the applying of an adhesive 18 to an interstice between the pressing member 17 and the heat radiation plate 51 makes it possible to more securely inhibit the formation of the gap between the heat radiation plate 51 and the case main body 21.

The light source 100 and the reflection plate 40 are housed in the thus-configured case 20 of this embodiment, as described above.

In this embodiment, a supporting member 30 is provided inside the case main body 21. The supporting member 30 supports the reflection plate 40.

The supporting member 30 includes a fixing portion 32 formed on its rear side in the main optical axis A1 direction. The fixing of the fixing portion 32 to the extended portion 53 causes the supporting member 30 to be fixed to the case main body 21 with the heat radiation unit 50 interposed in between. Moreover, an attachment piece 31 is provided to a front side of the supporting member 30 in the main optical axis A1 direction.

The reflection plate 40 is shaped almost like a bowl whose diameter becomes gradually larger toward its front side in the main optical axis A1 direction. The reflection plate 40 includes a front-side opening portion 43 formed on its front side in the main optical axis A1 direction, and a rear-side opening portion 42 formed on its rear side in the main optical axis A1 direction. Moreover, an inner surface of the reflection plate 40 serves as a reflection surface 41. The reflection surface 41 forms a part of a parabolic surface.

Furthermore, in this embodiment, the reflection plate 40 includes a flange portion 44 formed in the front-side opening portion 43 to extend outward from the front-side opening portion 43. The flange portion 44 is attached to the attachment piece 31 using screws 45. Thereby, the reflection plate 40 is attached to the supporting member 30.

Moreover, the light source 100 is placed in the back of the rear-side opening portion 42 of the reflection plate 40. In this case, it is desirable that a light-emitting surface (diffusing portion 190, albeit described later, in this embodiment) of the light source 100 be placed in a focus portion of the imaginary parabolic surface including the reflection surface 41. This enables the light emitted from the light source 100 to be reflected in the main optical axis A1 direction by the reflection surface 41, and the light whose rays are almost parallel to be projected to the outside through the panel 12 which is placed in front of the front-side opening portion 43 in the main optical axis A1 direction.

The light source 100 includes: multiple LEDs (light-emitting elements) 141 included in an LED group (light-emitting element group) 140; and the LED board (light-emitting element base) 130 on which the multiple LEDs (light-emitting elements) 141 are placed.

Furthermore, the multiple LEDs 141 are placed on a placement surface 130a of the LED board 130 in a way that a main optical axis A2 direction of the respective LEDs 141 coincides with a direction orthogonal to (intersecting) the placement surface 130a of the LED board 130.

In this embodiment, as described above, the multiple LEDs 141 are placed on the LED board 130 in the way that the main optical axis A2 direction of the respective LEDs 141 almost coincides with one another. In addition, in this embodiment, the main optical axis A2 direction coincides with the main optical axis A1 of the light source 100.

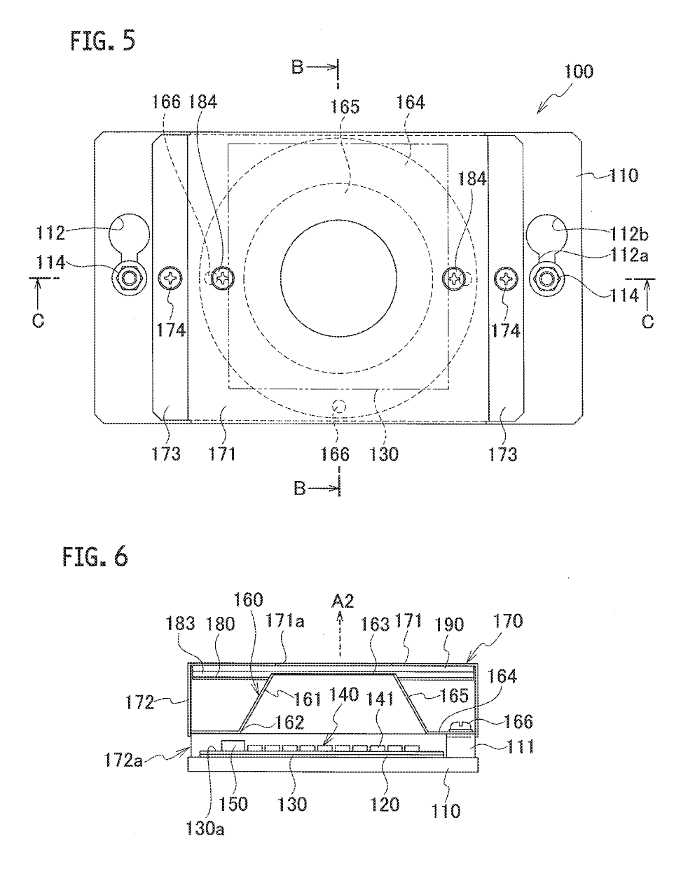

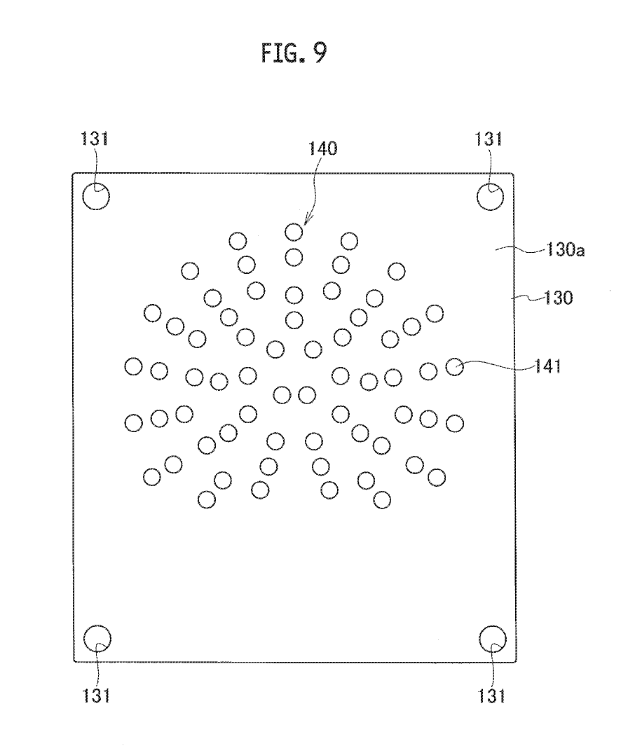

In this embodiment, as shown in FIGS. 5 to 8, the LED board 130 with the LED group 140 placed on its placement surface 130a is attached to an attachment board 110 with a pedestal 120 interposed in between. Incidentally, reference sign 131 shown in FIG. 9 denotes screw holes into which to insert screws to be used to attach the LED board 130 to the attachment board 110.

Besides, the multiple LEDs 141 include LEDs (light-emitting elements) with different colors. Four kinds of LEDs 141, that is to say, red LEDs, green LEDs, blue LEDs and white LEDs, are used for this embodiment. The LED group (light-emitting element group) 140 is formed from multiple red LEDs, multiple green LEDs, multiple blue LEDs and multiple white LEDs.

As shown in FIG. 9, the multiple LEDs 141 may be radially or coaxially placed on the placement surface 130a of the LED board 130. In that case, regardless of their colors, the LEDs may be randomly placed thereon. Otherwise, the LEDs may be radially or coaxially placed thereon in a way that areas of the placement surface 130a are assigned to the respective colors. Incidentally, how to place the LEDs is not limited to the above-mentioned ones.

The use of the multiple LEDs for each different color, as well as an appropriate adjustment of the light emission of each LED and an amount of light emitted from each LED enables the light source 100 to selectively emit the light of a desired color..

In the other words, the light source 100 of this embodiment is a light source capable of performing what is called full-color light emission. The use of the light source 100 like this makes the light projector (lighting apparatus) 1 capable of performing the full-color light emission.

In this point, this embodiment inhibits the color of the light emitted from the light source 100 from becoming uneven.

To put it concretely, the mixture of the light emitted from the LED group 140 is facilitated by a reflection plate 160 which is provided as a reflection unit configured to narrow the thus-emitted light (or to reflect the light in a way that directs the light toward the center of the LED group 140).

The reflection plate 160 includes: a reflection surface 161 configured to narrow the light emitted from the LED group 140; a front-side opening portion 163 formed on a front side of the reflection plate 160 in the main optical axis A2 (A1) direction; and a rear-side opening portion 162 formed in a rear side of the reflection plate 160 in the main optical axis A2 (A1) direction.

The reflection plate 160 further includes: a flat portion 164; and an inclined portion 165 continuously provided to the flat portion 164. An inner surface of the inclined portion 165 serves as the reflection surface 161.

In addition, the flat portion 164 is attached to a rib 111 projectingly provided to the attachment board 110 using screws 166. Thereby, the reflection plate 160 is attached to the attachment board 110.

The rib 111 is formed projecting forward of the LED group 140 in the main optical axis A2 (A1) direction. The inclined portion 165 (reflection surface 161) is placed forward of the LED group 140 in the main optical axis A2 (A1) direction.

Furthermore, the inclined portion 165 is shaped like a truncated cone whose diameter becomes gradually smaller toward its front side in the main optical axis A2 (A1) direction. The area of the front-side opening portion 163 is smaller than that of the rear-side opening portion 162.

In this embodiment, the reflection plate 160 is shaped like a truncated cone whose diameter becomes gradually smaller toward its front side in the main optical axis A2 (A1) direction, as described above.

Moreover, in this embodiment, in a view from the main optical axis A2 (A1) direction, all of the LED group 140 is placed inside the rear-side opening portion 162 (or is inside a region drawn by a rear-side end edge of the inclined portion 165).

Besides, in the view from the main optical axis A2 (A1) direction, the LEDs 141 placed on an outer periphery side of the LED group 140 are covered with the reflection unit 160 (inclined portion 165).

In addition, in the view from the main optical axis A2 (A1) direction, the LEDs 141 placed on a center side of the LED group 140 are placed inside the front-side opening portion 163. In other words, in the view from the main optical axis A2 (A1) direction, the LEDs 141 placed on the center side of the LED group 140 are exposed through the front-side opening portion 163.

Since as described above, in the view from the main optical axis A2 (A1) direction, all of the LED group 140 is placed inside the rear-side opening portion 162, the light emitted from the LED group 140 can be more efficiently sent out forward through the front-side opening portion 163.

Furthermore, since in the view from the main optical axis A2 (A1) direction, the LEDs 141 placed on the outer periphery side of the LED group 140 are covered with the reflection unit 160 (inclined portion 165), light emitted from the outer periphery side of the LED group 140 can be more securely reflected by the reflection surface 161. As a result, the light can be more securely mixed together.

Furthermore, since in the view from the main optical axis A2 (A1) direction, the LEDs 141 placed on the center side of the LED group 140 are placed inside the front-side opening portion 163, the rectilinear propagation of the light emitted from the center side of the LED group 140 is inhibited from being blocked by the reflection unit 160. Accordingly, the light emitted from the center side of the LED group 140 can be mixed together on the center side thereof.

Moreover, in a case of the configuration in which all of the LEDs of the same color, such as all the red LEDs, are exposed through the front-side opening portion 163, the emitted light of the color can smoothly reach the diffusing portion 190. This makes it possible for the light of the color to be more efficiently projected.

Besides, the diffusing portion 190 configured to diffuse the light is placed in front of the reflection unit 160 in the main optical axis A2 (A1) direction.

In this embodiment, an acrylic plate in a milky-white color (resin-made diffusion portion) is used as the diffusing portion 190. Furthermore, the acrylic plate (diffusing portion 190) is fixed to a ceiling wall portion 171 of a cover 170.

The cover 170 includes: the ceiling wall portion 171 to which the diffusing portion 190 is fixed; and side wall portions 172 covering the reflection unit 160.

The ceiling wall portion 171 includes an opening portion 171a facing the front-side opening portion 163. The acrylic plate (diffusing portion 190) is fixed to the ceiling wall portion 171 in a way to cover the opening portion 171a from the rear.

To put it specifically, the acrylic plate (diffusing portion 190) is fixed to the ceiling wall portion 171 by pressing an outer periphery 191 of the acrylic plate (diffusing portion 190) against the ceiling wall portion 171 using a metal-made pressing plate 180.

The pressing plate 180 includes: an attachment portion 181 to be fixed to the ceiling wall portion 171 using screws 184; and a pressing portion 182 configured to press the outer periphery 191 of the acrylic plate (diffusing portion 190). In addition, a packing 183 is interposed between the pressing portion 182 of the pressing plate 180 and the acrylic plate (diffusing portion 190).

Since as described above, the acrylic plate (diffusing portion 190) is fixed to the ceiling wall portion 171 with the packing 183 interposed between the pressing portion 182 and the acrylic plate (diffusing portion 190), noise can be inhibited from occurring due to touches between the resin and the metal.

Furthermore, the side wall portions 172 located at two longitudinal-direction ends of the cover 170 are provided with attachment pieces 173, respectively. The attachment pieces 173 are attached to the attachment board 110 using screws 174. Thereby, the cover 170 is attached to the attachment board 110.

It should be noted that gaps 172a are formed between the attachment board 110 and distal ends of the side wall portions 172 located at the two longitudinal-direction ends of the cover 170. The gaps 172a are provided there in order for the cable 71 to be inserted through the gaps 172a. Thus, the cable 71 inserted through the gaps 172a is electrically connected to the connector 150 placed (mounted) on the placement surface 130a of the LED board 130. Thereby, the power supply unit 70 is electrically connected to the LED board 130.

As described above, in this embodiment, the light emission by the LED group 140 can be controlled using the power supply unit 70. Thus, the brightness setting, color selection, etc. of the light to be projected from the light projector (lighting apparatus) 1 can be made by operating the power supply unit 70.

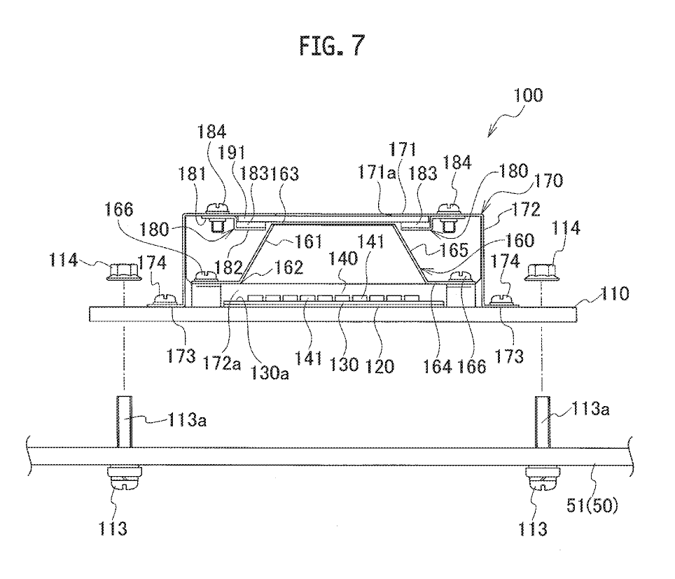

Moreover, in this embodiment, the light source 100 is formed as a module. As shown in FIG. 7, the light source 100 is detachably attached to the heat radiation plate 51 (case 20).

To put it specifically, the attachment board 110 includes holes 112 which allow shanks 113a of bolts 113, after inserted through the heat radiation plate 51, to be inserted through the holes 112. Nuts 114 are fastened to the bolts 113 with the shanks 113a of bolts 113 inserted through the holes 112. Thereby, the light source 100 formed as the module is attached to the heat radiation plate 51 (case 20).

Moreover, in this embodiment, each hole 112 has a keyhole shape including: an elongated hole 112a extending with a width larger than the diameter of the shank 113a of the bolt 113, but smaller than the diameter of the nut 114; and a round hole 112b whose diameter is larger than the diameter of the nut 114. For this reason, the light source 100 formed as the module can be attached to and detached from the heat radiation plate 51 (case 20) without detaching the nut 114 from the bolt 113.

To put it specifically, the light source 100 formed as the module can be detached from the heat radiation plate 51 (case 20) by: unfastening the nut 114; sliding the light source 100 formed as the module in an extension direction of the elongated hole 112a; and letting the nut 114 pass through the round hole 112b.

Meanwhile, the light source 100 formed as the module can be attached to the heat radiation plate 51 (case 20) by: letting the nut 114 pass through the round hole 112b of the light source 100 formed as the module; sliding the light source 100 formed as the module in the extension direction of the elongated hole 112a; and fastening the nut 114. In that case, it is desirable that in the view from the main optical axis A2 direction, the light source 100 be attached to the heat radiation plate 51 (case 20) with the center of the opening portion 171a of the light source 100 and the center of the rear-side opening portion 42 of the reflection plate 40 almost coinciding with each other.

In addition, in this embodiment, the rear-side opening portion 42 of the reflection plate 40 is placed forward of the opening portion 171a in the main optical axis A2 direction, and the diameter of the rear-side opening portion 42 is larger than that of the opening portion 171a. Thereby, the light sent out through the opening portion 171a can be more securely reflected by the reflection plate 40. Incidentally, the outer periphery of the light source 100 may be covered with the reflection plate 40.

Furthermore, in this embodiment, in the view from the main optical axis A2 direction, not only do the center of the opening portion 171a of the light source 100 and the center of the rear-side opening portion 42 of the reflection plate 40 almost coincide with each other, but also the centers of the front- and rear-side opening portion 163, 162 of the reflection unit 160, the center of the front-side opening portion 43 of the reflection plate 40, and the center of the panel 12 almost coincide with one another.

As described above, the light source 100 of this embodiment includes the multiple LEDs (light-emitting elements) 141. The color of each LED (light-emitting element) 141 falls into one of the different color categories. The multiple LEDs (light-emitting elements) 141 are included in the LED group (light-emitting element group) 140. The light source 100 further includes the LED board (light-emitting element base) 130 on which the LEDs (light-emitting elements) 141 are placed in the way that the main optical axis A2 direction coincide with the direction orthogonal to (or intersecting) the placement surface 130a.

The light source 100 further includes the reflection plate (reflection unit) 160 which includes: the reflection surface 161 configured to narrow the light emitted from the LED group 140; the front-side opening portion 163 formed on the front side of the reflection plate (reflection unit) 160 in the main optical axis A2 direction; and the rear-side opening portion 162 formed on the rear side of the reflection plate (reflection unit) 160 in the main optical axis A2 direction.

The light source 100 further includes the diffusing portion 190 placed forward of the reflection plate (reflection unit) 160 in the main optical axis A2 direction, and configured to diffuse the light.

In addition, the area of the front-side opening portion 163 is smaller than that of the rear-side opening portion 162.

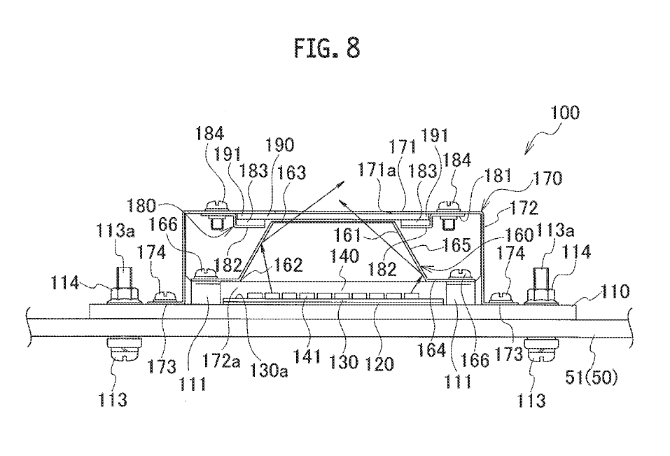

By these, the light emitted from the LED group (light-emitting element group) 140 are reflected inward by the reflection plate (reflection unit) 160 (see arrows in FIG. 8). Consequently, in the view from the main optical axis A2 direction, the mixture of the light is facilitated on the center side of the LED group (light-emitting element group) 140. Thus, the light more securely mixed is diffused by the diffusing portion 190. This makes it possible for the light source 100 to emit the light whose color is inhibited from becoming uneven.

In addition, since the light source 100 is used in the light projector (lighting apparatus) 1 which includes the reflection plate 40 configured to reflect the light emitted by the light source 100 in the main optical axis A1 direction of the light source 100, the light whose color is inhibited from becoming uneven can be projected to the outside of the light projector (lighting apparatus) 1.

According to this embodiment, as described above, it is possible to inhibit the color of the light from becoming uneven in the light source 100 capable of emitting the light of a color selected from the various colors and the light projector (lighting apparatus) 1 using such a light source 100.

Furthermore, in this embodiment, the reflection plate (reflection unit) 160 is shaped like a truncated cone whose diameter becomes gradually smaller toward its front side in the main optical axis A2 direction, as described above.

Thereby, the light emitted from the LEDs (light-emitting elements) 141 placed on the outer periphery side of the LED group (light-emitting element group) 140 can be more evenly directed toward the center of the LED group (light-emitting element group) 140. Accordingly, the color can be more securely inhibited from becoming uneven.

In addition, in this embodiment, in the view from the main optical axis A2 direction, the LED group 140 is placed inside the rear-side opening portion 162.

Thereby, the light emitted from the LED group 140 can be more efficiently projected forward through the front-side opening portion 163.

Furthermore, in the view from the main optical axis A2 direction, the LEDs 141 placed on the outer periphery side of the LED group 140 are covered with the reflection unit 160.

Thereby, the light emitted from the outer periphery side of the LED group 140 can be more securely reflected by the reflection surface 161, and can be more securely mixed.

Moreover, in this embodiment, in the view from the main optical axis A2 direction, the LEDs 141 placed on the center side of the LED group 140 are placed inside the front-side opening portion 163.

Thereby, the rectilinear propagation of the light emitted from the center side of the LED group 140 is inhibited from being blocked by the reflection unit 160, and the thus-emitted light can be accordingly mixed on the center side of the LED group 140.

Besides, in this embodiment, the light source 100 includes the cover 170 which includes: the ceiling wall portion 171 to which the diffusing portion 190 is fixed; and the side wall portions 172 covering the reflection plate (reflection unit) 160.

In addition, the diffusing portion 190 is made from the resin, and is fixed to the ceiling wall portion 171 in the way to cover the opening portion 171a formed in the ceiling wall portion 171.

In that case, the diffusing portion 190 is fixed to the ceiling wall portion 171 by pressing the outer periphery 191 against the ceiling wall portion 171 using the metal-made pressing plate 180, and the packing 183 is interposed between the pressing plate 180 and the diffusing portion 190.

Thereby, the noise can be inhibited from occurring due to touches between the resin and the metal.

### Second Embodiment

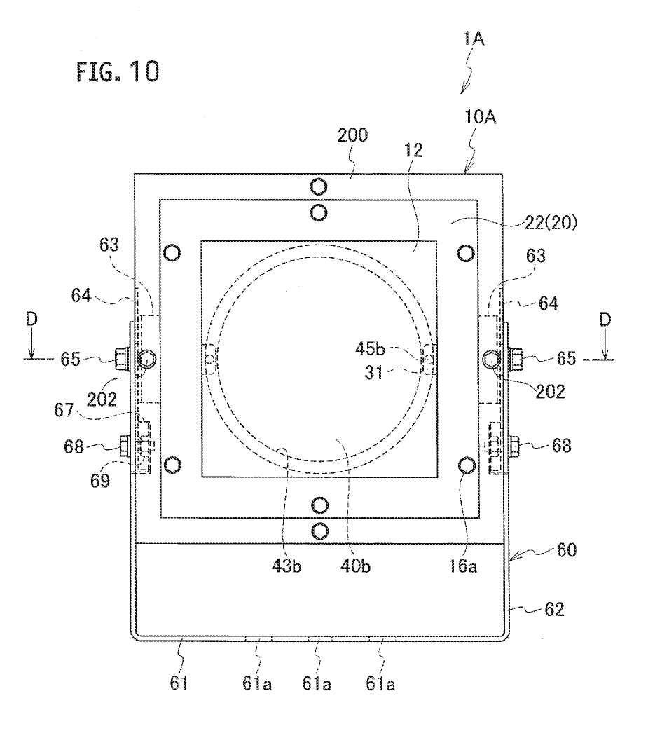

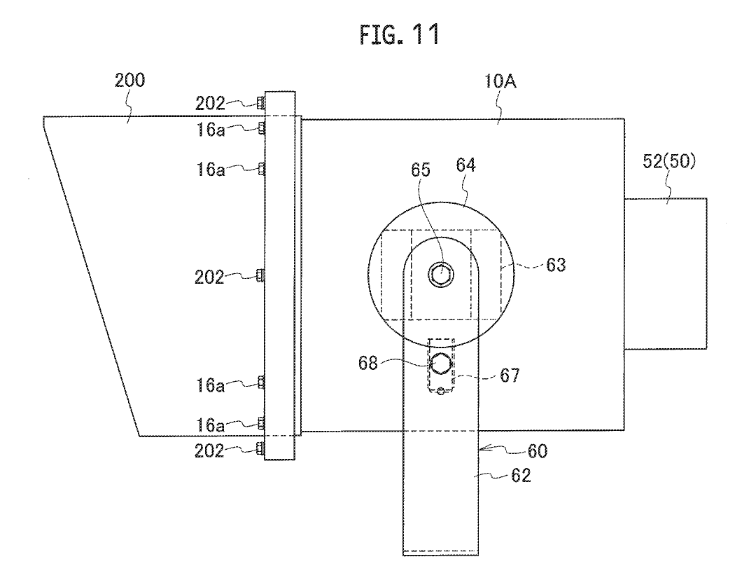

A light projector (lighting apparatus) 1A of this embodiment basically has almost the same configuration as does the light projector (lighting apparatus) 1 shown in the first embodiment. In other words, as shown in FIGS. 10 and 11, the light projector (lighting apparatus) 1A includes a light projector main body 10A including: the light source 100 housed inside the light projector main body 10A; and the panel 12 configured to allow the light emitted from the light source 100 to pass through the panel 12, and to be projected to the outside of the light projector main body 10A through the panel 12.

It should be noted that also in this embodiment, the light projector (lighting apparatus) 1A includes the power supply unit 70 electrically connected to the light projector main body 10A using the cable 71. However, the illustration of the power supply unit 70 is omitted in this embodiment.

The light source 100 to be used in this embodiment is the same as the light source 100 shown for the first embodiment.

As shown in FIGS. 10 and 11, in the light projector (lighting apparatus) 1A of this embodiment, a hood 200 is attached to the light projector main body 10A. The hood 200 restricts the light projection direction. In this embodiment, the hood 200 is attached to the light projector main body 10A using screws 202.

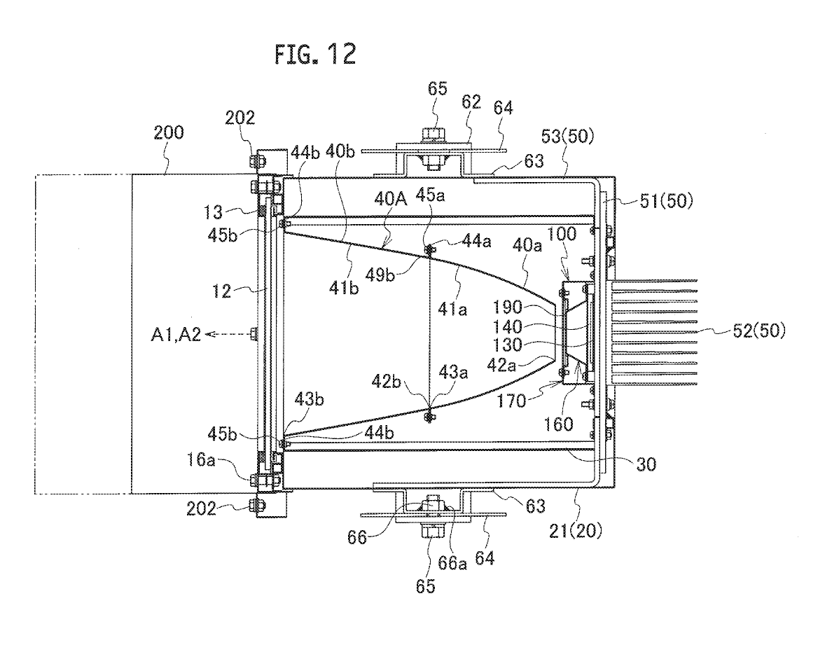

In addition, a reflection plate 40A includes: a first reflection plate 40a placed on the light source 100 side; and a second reflection plate 40b placed in front of the first reflection plate 40a in the main optical axis A2 direction of the LEDs, and continuously connected to the first reflection plate 40a (see FIG. 12) in a detachable manner.

To put it specifically, the first reflection plate 40a is shaped almost like a bowl whose diameter becomes gradually larger toward its front side in the main optical axis A1 direction. The first reflection plate 40a includes: a front-side opening portion 43a formed on its front side in the main optical axis A1 direction; and a rear-side opening portion 42a formed on its rear side in the main optical axis A1 direction. In addition, an inner surface of the reflection plate 40a serves as a reflection surface 41a. The reflection surface 41a forms a part of a parabolic surface.

Furthermore, in this embodiment, the first reflection plate 40a includes a flange portion 44a formed in the front-side opening portion 43a to extend outward from the front-side opening portion 43a. The flange portion 44a is attached to a flange portion 49b of the second reflection plate 40b (described later) using screws 45a. Thereby, the first reflection plate 40a is attached to the second reflection plate 40b.

As the first reflection plate 40a, one which is the same as the reflection plate 40 shown in the first embodiment may be used.

Meanwhile, the second reflection plate 40b is shaped almost like a bowl whose diameter becomes gradually larger toward its front side in the main optical axis A1 direction. The second reflection plate 40b includes: a front-side opening portion 43b formed on its front side in the main optical axis A1 direction; and a rear-side opening portion 42b formed on its rear side in the main optical axis A1 direction. In addition, an inner surface of the second reflection plate 40b serves as a reflection surface 41b. The reflection surface 41b forms a part of a parabolic surface.

Furthermore, in this embodiment, the second reflection plate 40b includes a flange portion 44b formed in the front-side opening portion 43b to extend outward from the front-side opening portion 43b. The flange portion 44b is attached to the attachment piece 31 using screws 45b. Thereby, the second reflection plate 40b is attached to the supporting member 30.

In addition, as described above, the second reflection plate 40b includes the flange portion 49b formed in the rear-side opening portion 42b to extend outward from the rear-side opening portion 42b. When the flange portion 49b is attached to the flange portion 44a using the screws 45a, the first reflection plate 40a and the second reflection plate 40b are integrally attached to each other. Thereby, the reflection plate 40A is formed from the first reflection plate 40a and the second reflection plate 40b. Here, the reflection surface 41a and the reflection surface 41b are smoothly and continuously connected to each other; and the reflection plate 40A is long in the main optical axis A1 direction. In other words, when continuously connected together, the first reflection plate 40a and the second reflection plate 40b form the integral parabolic surface.

Thereby, the reflection plate 40A obtained by continuously connecting the first reflection plate 40a and the second reflection plate 40b together can exert the same function as does a single piece of a reflection plate long in the main optical axis A1 direction.

To put it specifically, with the reflection plate 40A long in the main optical axis A1 direction, the light projector (lighting apparatus) 1A is capable of projecting the light into the distance. On the other hand, in the first embodiment where the reflection plate 40 is short in the main optical axis A1 direction, the light projection distance is shorter but a wider area can be lit than the reflection plate 40A.

It should be noted that although the reflection plate shown as the example in this embodiment is obtained by connecting the two reflection plate sub-components together, the reflection plate of this embodiment may be obtained by connecting three or more reflection-plate subcomponents together.

This embodiment described above can also bring about the same operation and effects as can the first embodiment.

Furthermore, in this embodiment, the reflection plate 40A includes: the first reflection plate 40a placed closer to the light source 100; and the second reflection plate 40b placed in front of the first reflection plate 40a in the main optical axis A2 direction of the LEDs (light-emitting elements), and continuously connected to the first reflection plate 40a in the detachable manner.

Since as described above, the reflection plate 40A long in the main optical axis A1 direction is formed from the first reflection plate 40a and the second reflection plate 40b, the reflection plate 40A can be easily manufactured compared with if the reflection plate 40A long in the main optical axis A1 direction were formed of a single piece of plate. In addition, this makes it possible to reduce manufacturing costs as well.

It should be noted that although the example of the first reflection plate 40a shown in this embodiment is supported by the second reflection plate 40b alone, that may be instead supported by the supporting member 30 to be usable even while the second reflection plate 40b is detached from the supporting member 30. This makes it possible to light a wider area or project the light into the distance by use of the single light projector.

### Third Embodiment

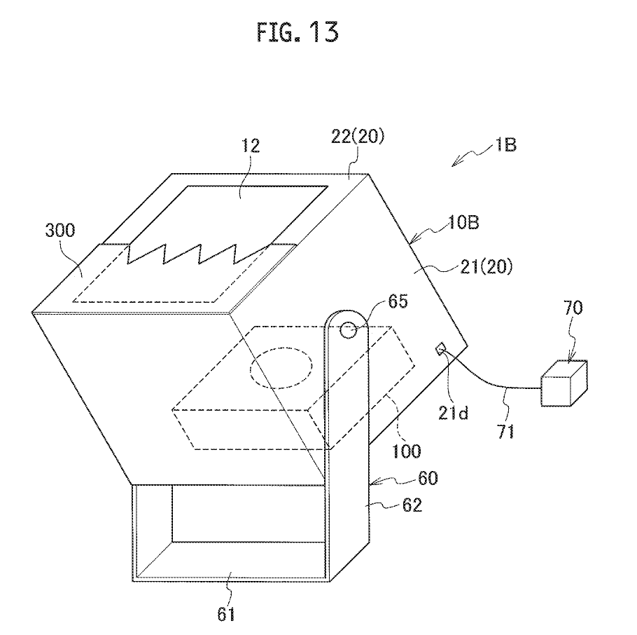

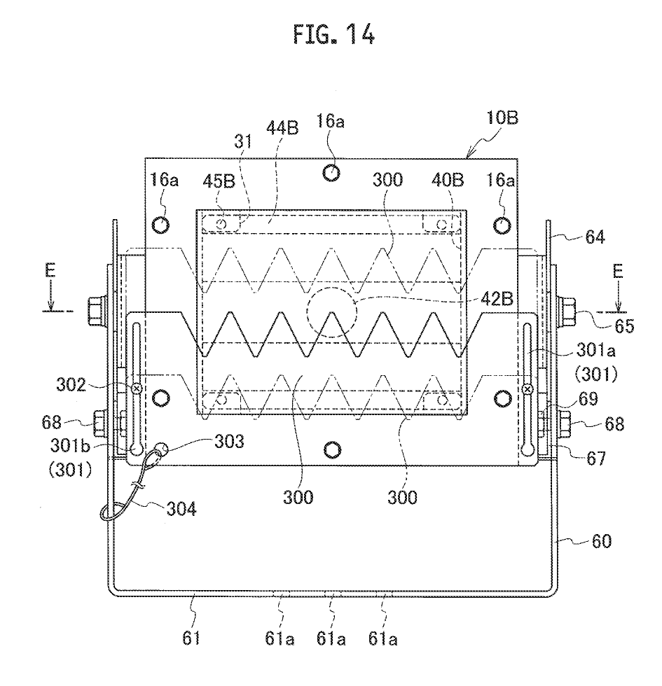

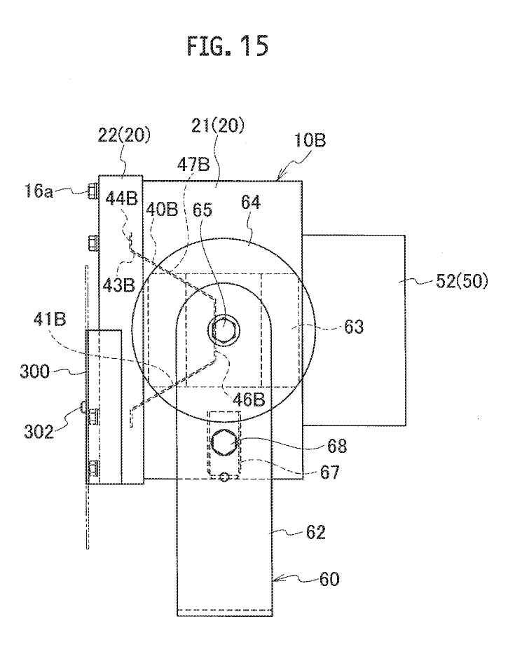

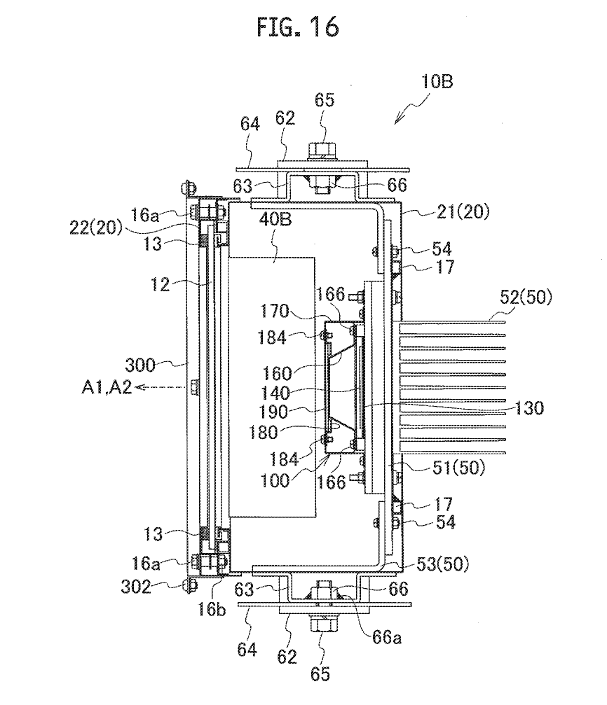

A light projector (lighting apparatus) 1B of this embodiment basically has almost the same configuration as does the light projector (lighting apparatus) 1 shown in the first embodiment. In other words, as shown in FIGS. 13 to 16, the light projector (lighting apparatus) 1B includes a light projector main body 10B including: the light source 100 housed inside the light projector main body 10B; and the panel 12 configured to allow the light emitted from the light source 100 to pass through the panel 12, and to be projected to the outside of the light projector main body 10B through the panel 12.

In addition, in this embodiment, too, the light projector (lighting apparatus) 1B includes the power supply unit 70 electrically connected to the light projector main body 10B using the cable 71.

Moreover, the light source 100 to be used in this embodiment is the same as the light source 100 shown for the first embodiment.

Furthermore, the light projector (lighting apparatus) 1B of this embodiment is provided with a light blocking plate 300 configured to cover the panel 12.

In this embodiment, holes 301 are formed in the light blocking plate 300. The light blocking plate 300 is fixed to the light projector main body 10B by inserting screws 302 through the holes 301.

It should be noted that in this embodiment, each hole 301 has a keyhole shape including: an elongated hole 301a extending with a width larger than the diameter of the shank of the screw 302, but smaller than the diameter of the head of the screw 302; and a round hole 301b whose diameter is larger than the diameter of the head of the screw 302. For this reason, the light blocking plate 300 can be slid, as well as be attached to and detached from the light projector main body 10B, without detaching the screws 302. A fixation hole 303 is formed in the light blocking plate 300. In a case where one end of a strap 304 is fixed to the fixation hole 303 and the other end of the strap 304 is fixed to the arm 60 or the like, the light blocking plate 300 can be prevented from being missing when the light blocking plate 300 is detached from the light projector main body 10B.

It should be noted that although the example of the light blocking plate 300 shown in this embodiment is that whose upper end is shaped like waves, the outline of the light blocking plate 300 may take on various shapes.

Moreover, in this embodiment, the shape of a reflection plate 40B is different from that of the reflection plate 40 shown in the first embodiment and that of the reflection plate 40A in the second embodiment.

In this embodiment, the reflection plate 40B takes on a shape obtained by bending a plate-shaped member. To put it specifically, the reflection plate 40B includes: a bottom wall portion 46B; and a pair of side wall portions 47B, 47B continuously joined to the two ends of the bottom wall portion 46B. Inner surfaces of the bottom wall portion 46B and the side wall portions 47B serve as the reflection surface 41B.

Moreover, a rear-side opening 42B shaped almost like a circle in a front view (view from the main optical axis A1 direction) is formed on a center side of the bottom wall portion 46B. The light source 100 is placed in the back of the rear-side opening 42B.

Besides, the pair of side wall portions 47B, 47B incline such that the distance between the side wall portions 47B, 47B becomes longer as they becomes farther from the bottom wall portion 46B. A front-side opening 43B shaped almost like a rectangle in the front view (view from the main optical axis A1 direction) is formed between the front ends of the pair of side wall portions 47B, 47B. In addition, flange portions 44B are formed in the front ends of the pair of side wall portions 47B, 47B. The reflection plate 40B is attached to the supporting member 30 by attaching the flange portions 44B to the attachment piece 31 using screws 45B.

This embodiment can also bring about the same operation and effects as can the first embodiment.

### Fourth Embodiment

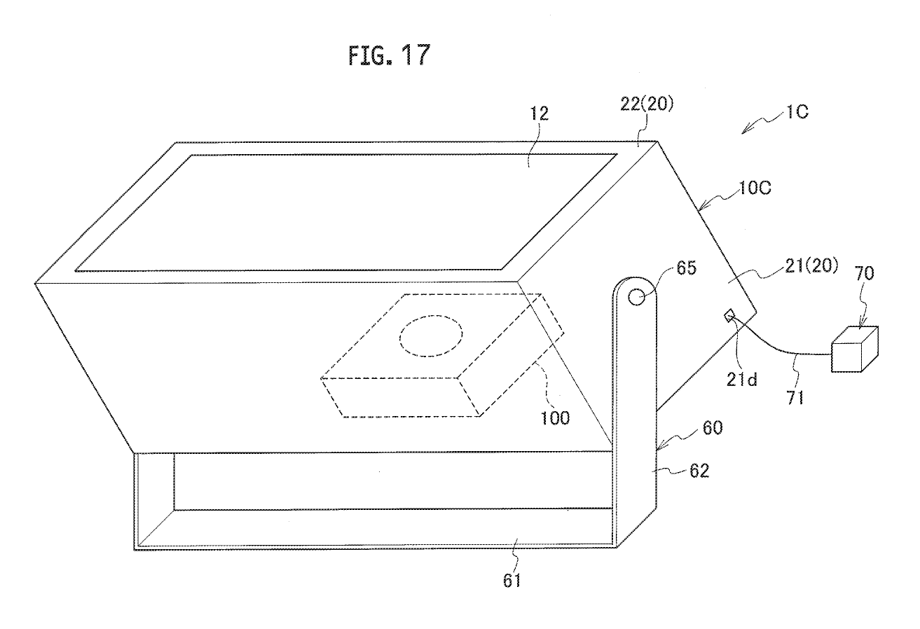

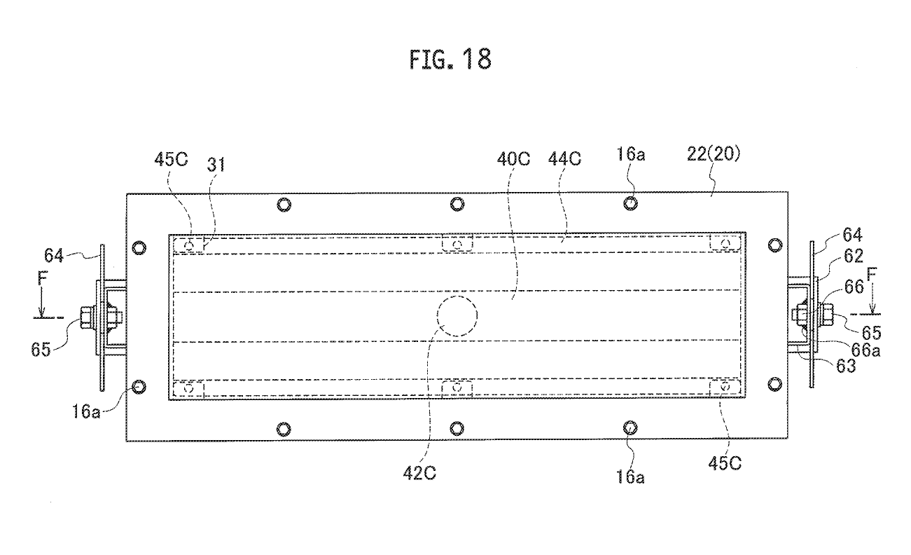

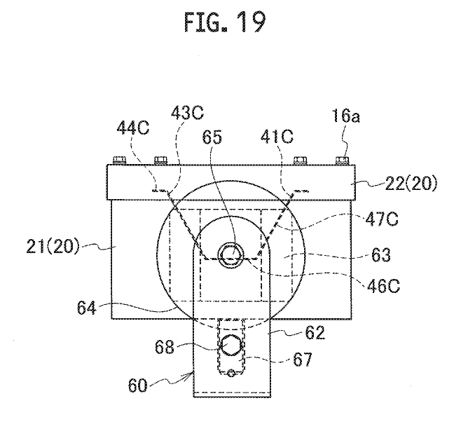

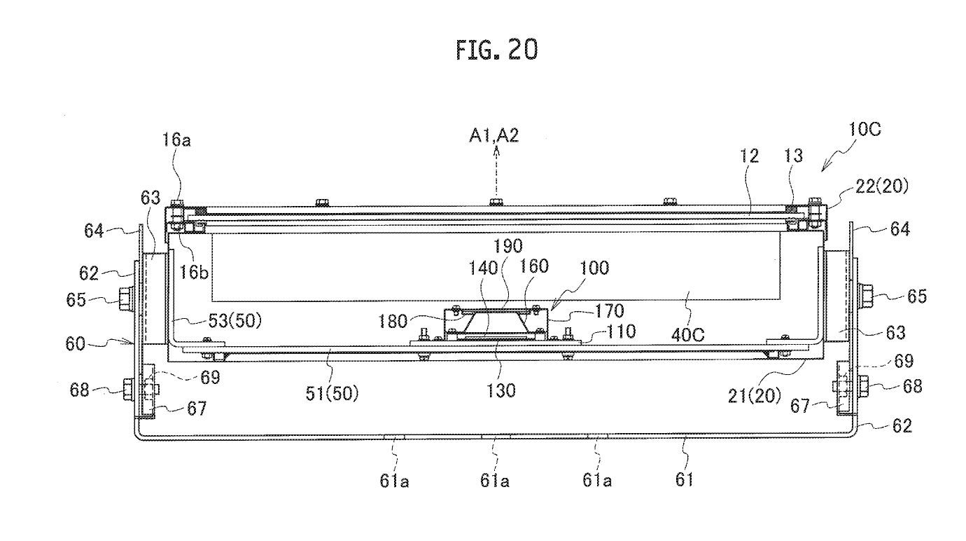

A light projector (lighting apparatus) 1C of this embodiment basically has almost the same configuration as does the light projector (lighting apparatus) 1 shown in the first embodiment. In other words, as shown in FIGS. 17 to 20, the light projector (lighting apparatus) 1C includes a light projector main body 10C including: the light source 100 housed inside the light projector main body 10C; and the panel 12 configured to allow the light emitted from the light source 100 to pass through the panel 12, and to be projected to the outside of the light projector main body 10C through the panel 12. Note that in this embodiment, the shape of the light projector main body 10C is a rectangular parallelepiped with a wide width.

In addition, in this embodiment, too, the light projector (lighting apparatus) 1C includes the power supply unit 70 electrically connected to the light projector main body 10C using the cable 71.

Moreover, the light source 100 to be used in this embodiment is the same as the light source 100 shown for the first embodiment.

In addition, in the light projector (lighting apparatus) 1C of this embodiment, the shape of a reflection plate 40C is different from that of the reflection plate 40 shown in the first embodiment and that of the reflection plate 40A of the second embodiment.

In this embodiment, the reflection plate 40C takes on a shape obtained by bending an elongated plate-shaped member. To put it specifically, the reflection plate 40C includes: a bottom wall portion 46C; and a pair of side wall portions 47C, 47C continuously joined to the two ends of the bottom wall portion 46C. Inner surfaces of the bottom wall portion 46C and the side wall portions 47C serve as the reflection surface 41C.

Moreover, a rear-side opening 42C shaped almost like a circle in a front view (view from the main optical axis A1 direction) is formed on a center side of the bottom wall portion 46C. The light source 100 is placed in the back of the rear-side opening 42C.

Besides, the pair of side wall portions 47C, 47C incline such that the distance between the side wall portions 47C, 47C becomes longer as they becomes farther from the bottom wall portion 46C. A front-side opening 43C shaped almost like a rectangle in the front view (view from the main optical axis A1 direction) is formed between the front ends of the pair of side wall portions 47C, 47C. In addition, flange portions 44C are formed in the front ends of the pair of side wall portions 47C, 47C. The reflection plate 40C is attached to the supporting member 30 by attaching the flange portions 44C to the attachment piece 31 using screws 45C.

This embodiment can also bring about the same operation and effects as can the first embodiment.

It should be noted that although an example of the heat radiation unit shown in this embodiment is provided with no radiation fins because the area of the heat radiation plate 51 is large enough, the heat radiation unit may be provided with the radiation fins which are shown in the first to third embodiments. Otherwise, the radiation fins may be excluded from the first to third embodiments.

This disclosure has described the preferable embodiments by showing the examples, the present invention is not limited to the foregoing embodiments, and can be modified variously.

For example, although the foregoing embodiments have shown the light projectors for outdoor use as their examples of the lighting apparatuses, the present invention is applicable to lighting apparatuses, such as a downlight, which are attached to ceilings.

In addition, although the foregoing embodiments have shown the LEDs as their examples of the light-emitting elements, the present invention is applicable to light-emitting elements such as a semiconductor light source.

Furthermore, although the foregoing embodiments have shown the reflection plates shaped like a truncated cone as their examples, the shapes of the reflection plates are not limited to this one. The reflection plates may take on any shape as long as the shape allows the passage of the light to be adjusted.

Moreover, lighting apparatuses may be obtained by appropriately combining the configurations shown in the foregoing embodiments, such as by providing the hood to the light projector main body shown in the first embodiment.

Besides, the case main body, the panel, and other detailed specifications (shapes, sizes, layouts and the like) may be changed appropriately.

What is claimed is:

1. A light source comprising:
a plurality of light-emitting elements of different colors, the light-emitting elements forming a light-emitting element group;
a light-emitting element base on which the light-emitting elements are placed in a way that a main optical axis direction of the light-emitting elements is a direction intersecting a placement surface of the light-emitting element base;
a reflection unit including
a reflection surface configured to narrow light emitted from the light-emitting element group,
a front-side opening portion formed on a front side of the reflection unit in the main optical axis direction, and
a rear-side opening portion formed on a rear side of the reflection unit in the main optical axis direction; and
a diffusing portion placed in front of the reflection unit in the main optical axis direction, and configured to diffuse the light, wherein
in the reflection unit, an area of the front-side opening portion is smaller than that of the rear-side opening portion.

2. The light source according to claim 1, wherein
the reflection unit is in a truncated cone shape whose diameter becomes gradually smaller toward the front side in the main optical axis direction.

3. The light source according to claim 1, wherein
in a view from the main optical axis direction, the light-emitting element group is placed inside the rear-side opening portion.

4. The light source according to claim 3, wherein
in the view from the main optical axis direction, light-emitting elements placed on an outer periphery side of the light-emitting element group are covered with the reflection unit.

5. The light source according to claim 3, wherein
in the view from the main optical axis direction, light-emitting elements placed on a center side of the light-emitting element group are placed inside the front-side opening portion.

6. The light source according to claim 1, further comprising
a cover including
a ceiling wall portion to which the diffusing portion is fixed, and
a side wall portion covering the reflection unit, wherein
the diffusing portion is made of resin,
the diffusing portion is fixed to the ceiling wall portion in a way to cover an opening portion formed in the ceiling wall portion, and
the diffusing portion is fixed to the ceiling wall portion by pressing its outer periphery against the ceiling wall portion using a pressing plate made of metal, and
a packing is interposed between the pressing plate and the diffusing portion.

7. A lighting apparatus comprising:
a light source; and
a reflection plate configured to reflect light emitted from the light source in a main optical axis direction of the light source, wherein
the light source includes
a plurality of light-emitting elements of different colors, the light-emitting elements forming a light-emitting element group,
a light-emitting element base on which the light-emitting elements are placed in a way that a main optical axis direction of the light-emitting elements is a direction intersecting a placement surface of the light-emitting element base,
a reflection unit including
a reflection surface configured to narrow the light emitted from the light-emitting element group,
a front-side opening portion formed on a front side of the reflection unit in the main optical axis direction of the light-emitting elements, and
a rear-side opening portion formed on a rear side of the reflection unit in the main optical axis direction of the light-emitting elements, and
a diffusing portion placed in front of the reflection unit in the main optical axis direction of the light-emitting elements, and configured to diffuse the light, and
in the reflection unit, an area of the front-side opening portion is smaller than that of the rear-side opening portion.

8. The lighting apparatus according to claim 7, wherein
the reflection plate includes
a first reflection plate placed on the light source side, and
a second reflection plate placed in front of the first reflection plate in the main optical axis direction of the light-emitting elements, and continuously connected to the first reflection plate in a detachable manner.

9. The lighting apparatus according to claim 8, wherein
the first reflection plate and the second reflection plate continuously connected together form an integral parabolic surface.
